(19) United States
(12) Patent Application Publication
(10) Pub. No.: US 2025/0191134 A1
(43) Pub. Date: Jun. 12, 2025

(54) ELECTRONIC DEVICE AND METHOD FOR PROCESSING IMAGE INCLUDING TEXT

(71) Applicant: Samsung Electronics Co., Ltd., Suwon-si (KR)

(72) Inventors: Junghyun PARK, Suwon-si (KR); Niladri MUKHERJEE, Suwon-si (KR)

(21) Appl. No.: 19/057,440

(22) Filed: Feb. 19, 2025

Related U.S. Application Data
(63) Continuation of application No. PCT/KR2023/009041, filed on Jun. 28, 2023.

(30) Foreign Application Priority Data
Aug. 26, 2022 (KR) 10-2022-0107980
Sep. 5, 2022 (KR) 10-2022-0112446

(51) Int. Cl. G06T 5/50; G06T 3/4046; G06T 5/60; G06T 5/73; G06V 30/19

(52) U.S. Cl. CPC G06T 5/50; G06T 3/4046; G06T 5/60; G06T 5/73; G06V 30/19007; G06T 2207/20084; G06T 2207/20221

(57) ABSTRACT

An electronic device may comprise: at least one processor, comprising processing circuitry, and at least one camera. At least one processor, individually and/or collectively, may be configured to: acquire a plurality of images through at least one camera; generate a first image using the plurality of images; identify a character area in the first image based on identifying that the plurality of images is related to text; generate a second image in which the character area in the first image is enhanced; and generate an output image by blending the character area in the first image and a character area in the second image based on text attributes of the character area in the first image.

### CROSS-REFERENCE TO RELATED APPLICATIONS

This application is a continuation of International Application No. PCT/KR2023/009041 designating the United States, filed on Jun. 28, 2023, in the Korean Intellectual Property Receiving Office and claiming priority to Korean Paten Application Nos. 10-2022-0107980, filed on Aug. 26, 2022, and 10-2022-0112446, filed on Sep. 5, 2022, in the Korean Intellectual Property Office, the disclosures of each of which are incorporated by reference herein in their entireties.

### BACKGROUND

### Field

The disclosure relates to an electronic device and a method for processing an image including text.

### Description of Related Art

An electronic device including a camera may improve an image obtained through the camera, through a neural network. The electronic device may obtain an image with improved image quality by synthesizing each partial area of a plurality of images obtained through the camera.

The above-described information may be provided as a related art for the purpose of helping understanding of the present disclosure. No assertion is made as to whether any of the above description may be applied as a prior art related to the present disclosure.

### SUMMARY

According to an example embodiment, an electronic device may comprise: at least one processor, comprising processing circuitry, and at least one camera, wherein at least one processor, individually and/or collectively, may be configured to: obtain a plurality of images through the at least one camera; generate a first image using the plurality of images; based on identifying that the plurality of images are related to a text, identify a character area within the first image; generate a second image on which reinforce processing is performed on the character area within the first image; and generate an output image by blending the character area within the first image and a character area within the second image based on a text property of the character area within the first image.

According to an example embodiment, a method performed by an electronic device may comprise: obtaining a plurality of images through at least one camera; generating a first image using the plurality of images; based on identifying that the plurality of images are related to a text, identifying a character area within the first image; generating a second image on which reinforce processing is performed on the character area; and generating an output image by blending the character area within the first image and a character area within the second image based on a text property of the character area within the first image.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a block diagram of an example electronic device within a network environment according to various embodiments;

FIG. 2 illustrates an example of output image generation, according to various embodiments;

FIG. 3 is a flowchart illustrating an example output image generation operation, according to various embodiments;

FIG. 4 is a flowchart illustrating an example second image generation operation, according to various embodiments;

FIG. 5 is a flowchart illustrating an example output image generation operation performed based on a blending weight, according to various embodiments;

FIG. 6 is a diagram illustrating an example of first image generation, according to various embodiments;

FIG. 7 is a diagram illustrating an example of second image generation, according to various embodiments.

FIG. 8 is a diagram illustrating an example of blending weight identification, according to various embodiments.

FIG. 9 is a diagram illustrating example operations of generating an output image, according to various embodiments.

FIG. 10 is a diagram illustrating example operations of generating an output image based on text area identification, according to various embodiments.

### DETAILED DESCRIPTION

Terms used in the present disclosure are used to describe various example embodiments, and are not intended to limit the scope of the disclosure. A singular expression may include a plural expression unless the context clearly indicates otherwise. Terms used herein, including a technical or a scientific term, may have the same meaning as those generally understood by a person with ordinary skill in the art described in the present disclosure. Among the terms used in the present disclosure, terms defined in a general dictionary may be interpreted as the same or similar meaning as the contextual meaning of the relevant technology, and are not interpreted as ideal or excessively formal meaning unless explicitly defined in the present disclosure. In some cases, even terms defined in the present disclosure may not be interpreted to exclude embodiments of the present disclosure.

In various embodiments of the present disclosure described below, a hardware approach will be described as an example. However, since the various embodiments of the present disclosure include technology that uses both hardware and software, the various embodiments of the present disclosure do not exclude a software-based approach.

A term referring to combination (e.g., combining, merging, and compositing), a term referring to an area including text (e.g., an area including text, a text area, and an area), a term referring to a word area within a text area (a word area within a text area, and a word area), a term referring to a specified value (a reference value, and a threshold value), and the like that are used in the following description are used for convenience of explanation. Therefore, the present disclosure is not limited to terms to be described below, and another term having an equivalent technical meaning may be used. In addition, a term such as ‘ . . . unit, ‘ . . . device’, ‘ . . . module’, and ‘ . . . member’, and the like used below may refer, for example, to at least one shape structure or may refer, for example, to a unit processing a function.

In addition, in the present disclosure, a term ‘greater than’ or ‘less than’ may be used to determine whether a particular condition is satisfied or fulfilled, but this is only a description to express an example and does not exclude a description of ‘greater than or equal to’ or ‘less than or equal to’. A condition described as ‘greater than or equal to’ may be replaced with ‘greater than’, a condition described as ‘less than or equal to’ may be replaced with ‘less than’, and a condition described as ‘greater than or equal to and less than’ may be replaced with ‘greater than and less than or equal to’. In addition, hereinafter, ‘A’ to ‘B’ may refer, for example, to at least one of elements from A (including A) to B (including B). Hereinafter, ‘C’ and/or ‘D’ may refer, for example, to at least one of ‘C’ or ‘D’, that is, {‘C’, ‘D’, ‘C’ and ‘D’}.

Prior to describing various example embodiments of the present disclosure, terms used to describe operations of an electronic device according to various embodiments are described. An obtained image may refer, for example, to a frame obtained by a camera. A first image may refer, for example, to a frame generated based on a plurality of obtained images obtained by the camera. A second image may refer, for example to a frame with reinforce processing for the character area within the first image. An output image may refer, for example, to an image that is output to a display. A text area may refer, for example, to an area with a high probability of including text in an image. A character area may refer, for example, to a portion of an image included in the text area and including a character by a designated standard.

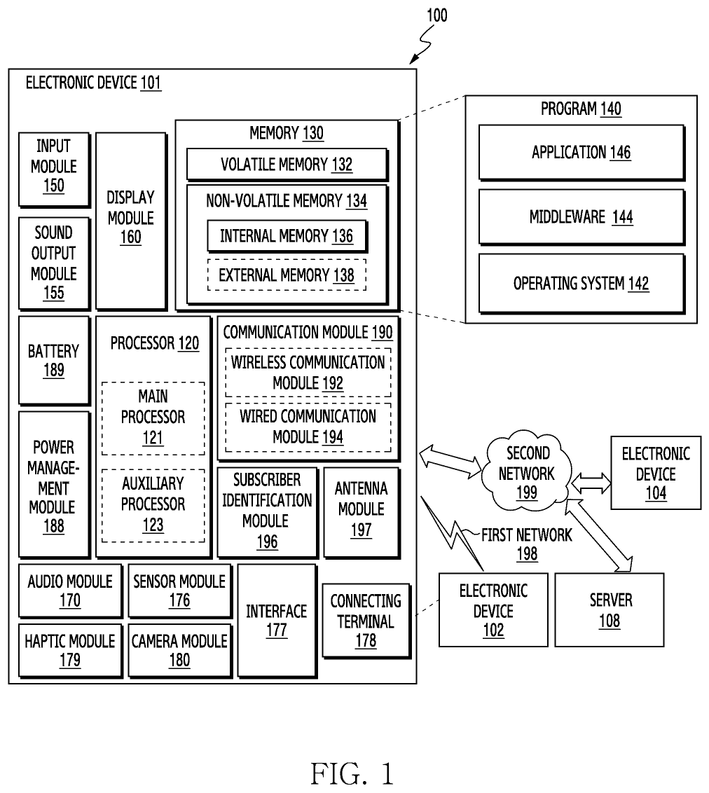

FIG. 1 is a block diagram illustrating an example electronic device 101 in a network environment 100 according to various embodiments.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In various embodiments, at least one of the components (e.g., the connecting terminal 178) may be omitted from the electronic device 101, or one or more other components may be added in the electronic device 101. In various embodiments, some of the components (e.g., the sensor module 176, the camera module 180, or the antenna module 197) may be implemented as a single component (e.g., the display module 160).

The processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mm Wave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

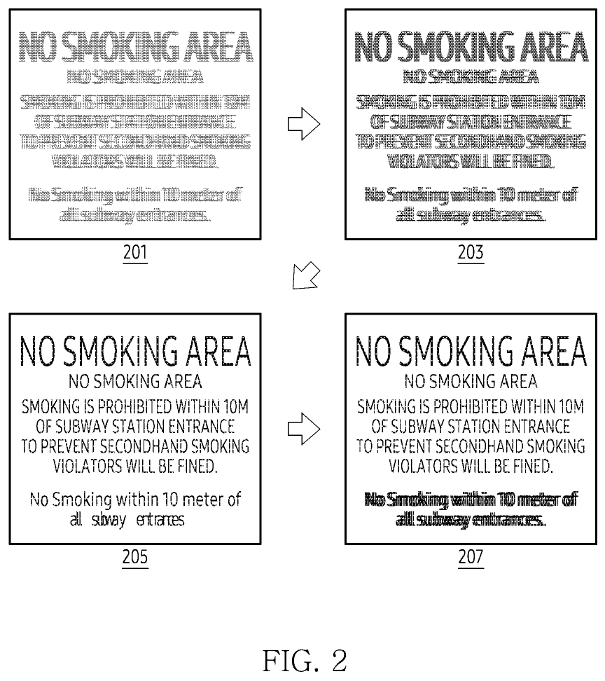

FIG. 2 is a diagram illustrating an example of output image generation, according to various embodiments.

Referring to FIG. 2, an obtained image 201 may be one of a plurality of images obtained through a camera 180. A first image 203 may be generated based on the plurality of images. A second image 205 may be generated by performing reinforce processing on a character area in the first image. An output image 207 may be generated by blending the character area within the first image and a character area within the second image.

According to an embodiment, the at least one processor may obtain the plurality of images through the camera 180. The obtained image 201, which is one of the plurality of images, may include one or more texts. For example, the obtained image 201 may include text with respect to a notice written on a blackboard. For example, the obtained image 201 may include text with respect to a precaution included in a sign. For example, the obtained image 201 may include text with respect to a wireless fidelity (Wi-Fi) password attached to a wall. An intention of a user photographing an image including text may be to record the text. Text included in the obtained image 201 may lack accuracy and clarity. For example, the text may be seen blurry due to a shaky focus. For example, it may be difficult to identify a portion of the text by reflected light.

According to an embodiment, the first image 203 may be generated by compositing portions having high clarity among the plurality of images, through a neural network for generating the first image. For example, the plurality of images may include an obtained first image, an obtained second image, and an obtained third image. The at least one processor 120 may identify a first subregion having high clarity within the obtained first image through the neural network for generating the first image. The at least one processor 120 may identify a second subregion having high clarity within the obtained second image through the neural network for generating the first image. The at least one processor 120 may identify a third subregion having high clarity within the obtained third image through the neural network for generating the first image. The at least one processor 120 may generate the first image 203 by compositing the first subregion, the second subregion, and the third subregion, through the neural network for generating the first image. The obtained first image, the obtained second image, and the obtained third image may be obtained by varying an exposure value. An exposure value of the obtained first image, an exposure value of the obtained second image, and an exposure value of the obtained third image may be different from each other. Regardless of an area including text, the clarity of the first image 203 may be improved overall compared to the clarity of the obtained image 201.

According to an embodiment, the second image 205 may be generated based on the first image 203, through a neural network for generating the second image. The at least one processor 120 may identify a text area that has a probability containing text greater than or equal to a reference value within the first image 203, through the neural network for generating the second image. The at least one processor 120 may identify a plurality of characters in the text area within the first image 203 through the neural network for generating the second image. The at least one processor 120 may identify a character area included in the text area within the first image through the neural network for generating the second image. The number of characters included in the character area may be determined by a designated standard. For example, the character area may include only an individual character in case that a size of the individual character (e.g., ‘N’, ‘O’, ‘S’, ‘M’, ‘O’, ‘K’, ‘I’, ‘N’, ‘G’, ‘A’, ‘R’, ‘E’, and ‘A’) included in the text area (e.g., ‘NO SMOKING AREA’) is greater than or equal to a designated threshold value. The character area may include a plurality of characters in case that the size of the character (e.g., ‘N’, ‘O’, ‘S’, ‘M’, ‘O’, ‘K’, ‘I’, ‘N’, ‘G’, ‘A’, ‘R’, ‘E’, and ‘A’) included in the text area (‘NO SMOKING AREA’) is less than the designated threshold value. For example, the character area may include only the individual character in case that a space between the characters included in the text area (‘NO SMOKING AREA’) is greater than or equal to the designated threshold value. The character area may include a plurality of characters in case that the space between the characters included in the text area is less than the designated threshold value. The at least one processor 120 may perform reinforce processing on the character area, through the neural network for generating the second image. The at least one processor 120 may generate the second image on which reinforce processing is performed on the character area, through the neural network for generating the second image. The neural network for generating the second image may be a natural processing unit (NPU). The NPU may be in a state in which learning is completed.

According to an embodiment, the output image 207 may be generated by blending the first image 203 and the second image 205. The output image 207 may be generated by blending the character area within the first image 203 and the character area within the second image 205, based on a blending weight. The blending weight may refer, for example, to a ratio of the character area within the second image 205 with respect to the character area within the first image 203. Clarity with respect to a letter of the first image 203 may be lower than clarity with respect to a letter of the second image 205. The clarity may refer, for example, to a degree to which a background and a periphery of a character are contrasted. As the clarity is higher, visuality may be higher. Accuracy with respect to a character of the first image 203 may be higher than accuracy with respect to a character of the second image 205. The accuracy may refer, for example, to a degree to which the character is not recognized as another character by the user. As the accuracy is higher, typos of the character may be fewer. Therefore, the at least one processor 120 may generate an output image with higher clarity than the first image 203 and higher accuracy than the second image 205, by blending the first image 203 with high accuracy and the second image 205 with high clarity. In case that the text area is not identified, the at least one processor 120 may not generate the second image 205. Accordingly, the at least one processor 120 may output the first image 203 as the output image 207. In case that the text area is identified, the at least one processor 120 may generate the output image 207, by blending the first image 203 and the second image 205 generated based on the first image 203. The blending weight may be obtained by a blending weight identification module. The blending weight identification module may identify the blending weight based on a text property. The text property may include a size of a character included in a character area, a matching probability identified by an optical character recognition (OCR) module, a distance from a center of the first image 203 to a center of the character area, an ISO value, a sensor gain, a degree of blur, a color of a character, and/or a thickness of the character.

According to an embodiment, as a size of the individual character within the character area is larger, a blending ratio of the character area within the second image may be set to be higher. This is because a probability of an artifact occurring may be lower as the size of the character area is larger. The artifact may be a defect with respect to a character caused by noise within the first image 203. As a size of a letter is larger, the probability of the artifact occurring may be lower. Therefore, as the size of the letter is larger, the at least one processor 120 may set the ratio of the character area within the second image 205 to be higher than a ratio of the character area within the first image 203.

According to an embodiment, as the matching probability obtained through the optical character recognition (OCR) module is larger, the blending ratio of the character area within the second image 205 may be set to be higher. The matching probability may be a probability that the character in the character area is a character identified through the optical character recognition (OCR) module. For example, the last word among English letters within the first image 203 may configure one character area. The optical character recognition (OCR) module may identify a character of the character area as ‘entrances’. The optical character recognition (OCR) module may identify a matching probability that is a probability in which the character within the character area is ‘entrances’. This may be because the probability of the artifact occurring may be lower as the matching probability is higher. Therefore, as the matching probability is higher, the at least one processor 120 may set the ratio of the character area within the second image 205 to be higher than the ratio of the character area within the first image 203.

According to an embodiment, as a distance from the center of the first image 203 to the center of the character area is closer, the blending ratio of the character area within the second image 205 may be set to be higher. This is because the probability of the artifact occurring may be lower as the distance from the center of the first image 203 to the center of the character area is closer. This is because an image is less blurry as the distance from the center of the first image 203 to the center of the character area is closer. In the at least one processor 120, there are many cases in which a portion closer to the outside of an image is blurrier than a center of the image. Therefore, as the character area is closer to the center of the image, accuracy of the character may increase. Therefore, as the distance from the center of the first image 203 to the center of the character area is closer, the at least one processor 120 may set the ratio of the character area within the second image 205 to be higher than the ratio of the character area within the first image 203.

According to an embodiment, as an international standards organization (ISO) value of the character area is lower, the blending ratio of the character area within the second image 205 may be set to be higher. This is because a probability of noise occurring within the character area may be lower as the international standards organization (ISO) value of the character area is lower. This is because the probability of the artifact occurring may be lower as the probability of noise occurring within the character area is lower. Therefore, the accuracy of the character may increase, since the probability of the artifact occurring is lower as the international standards organization (ISO) value of the character area is lower. Accordingly, as the international standards organization (ISO) value of the character area is lower, the least one processor 120 may set the ratio of the character area within the second image 205 to be higher than the ratio of the character area within the first image 203.

According to an embodiment, as a thickness of the character included in the character area is thicker, the blending ratio of the character area within the second image 205 may be set to be higher. This is because the probability of the noise occurring within the character area may be lower as the thickness of the character included in the character area is thicker. This is because the probability of the artifact occurring may be lower as the probability of the noise occurring within the character area is lower. Therefore, the accuracy of the character may increase, since the probability of the artifact occurring is lower as the thickness of the character included in the character area is thicker. Therefore, as the thickness of the character included in the character area is thicker, the at least one processor 120 may set the ratio of the character area within the second image 205 to be higher than the ratio of the character area within the first image 203.

According to an embodiment, as a degree of blur of the character included in the character area is lower, the blending ratio of the character area within the second image 205 may be set to be higher. The degree of blur may be identified by a blur estimation module. This is because the probability of the noise occurring within the character area may be lower as the degree of blur of the character included in the character area is lower. This is because the probability of the artifact occurring may be lower as the probability of the noise occurring within the character area is lower. Therefore, as the degree of blur of the character included in the character area is lower, the probability of the artifact occurrence is lower. If the probability of the artifact occurrence is lower, the accuracy of the character may increase. Therefore, as the degree of blur of the character is lower, the at least one processor 120 may set the ratio of the character area within the second image 205 to be higher than the ratio of the character area within the first image 203.

In the present disclosure, the first image or the second image may be generated through a neural network for generating an image. The neural network may refer, for example, to a model having an ability to solve or address a problem by changing a combination strength of synapses based on training nodes forming a network through a combination of the synapses. The neural network may be trained through supervised learning or unsupervised learning. For example, the supervised learning may refer, for example, to learning performed by providing a label (or a correct answer). Since the supervised learning requires the label, the supervised learning may require less resources than the unsupervised learning to evaluate reliability of output data derived from the neural network. On the other hand, since the supervised learning requires the label, the supervised learning may require resources (e.g., time resources) for obtaining the label. For another example, the unsupervised learning may refer, for example, to learning performed without a label. Since the unsupervised learning does not require the label, the unsupervised learning may not require the resources for obtaining the label. On the other hand, since the unsupervised learning does not require the label, the unsupervised learning may require more resources than the supervised learning to evaluate the reliability of the output data derived from the neural network.

In an embodiment, the neural network may be trained through unsupervised learning. In an embodiment, the neural network may include a plurality of layers. For example, the neural network may include an input layer, one or more hidden layers, and an output layer. Signals generated from each of the nodes in the input layer based on input data may be transmitted from the input layer to the one or more hidden layers. The output layer may obtain output data of the neural network based on one or more signals received from the one or more hidden layers.

The input layer, the one or more hidden layers, and the output layer may include a plurality of nodes. The one or more hidden layers may include, for example, a convolution filter or a fully connected layer in a convolution natural network (CNN), or various types of filters or layers connected based on a specific function or feature. In an embodiment, the one or more hidden layers may be layers based on a recurrent neural network (RNN) in which an output value is input again to a hidden layer of the current time. In an embodiment, the one or more hidden layers may be configured in plural, and may form a deep neural network. For example, training a neural network including the one or more hidden layers that form at least a portion of the deep neural network may be referred to as deep learning.

A node included in the one or more hidden layers may be referred to as a hidden node.

Nodes included in the input layer and the one or more hidden layers may be connected to each other through a connection line having a connection weight, and nodes included in the one or more hidden layers and the output layer may also be connected to each other through the connection line having the connection weight. Tuning and/or training a neural network may refer, for example, to changing the connection weight between nodes included in each of the layers (e.g., the input layer, the one or more hidden layers, and the output layer) included in the neural network. For example, the tuning or the training of the neural network may be performed based on the unsupervised learning.

According to an embodiment, a method according to various embodiments of the present disclosure may be provided by being included in a computer program product. The computer program product may be traded between a seller and a buyer as a commodity. The computer program product may be distributed in a form of a device-readable storage medium (e.g., compact disk read only memory (CD-ROM)), or may be distributed (e.g., download or upload) online directly through an application store (e.g., the play store) or between two user devices (e.g., smartphones). In case of the online distribution, at least a portion of the computer program product may be at least temporarily stored or provisionally generated in the device-readable storage medium such as memory of a server of a manufacturer, a server of the application store, or a relay server.

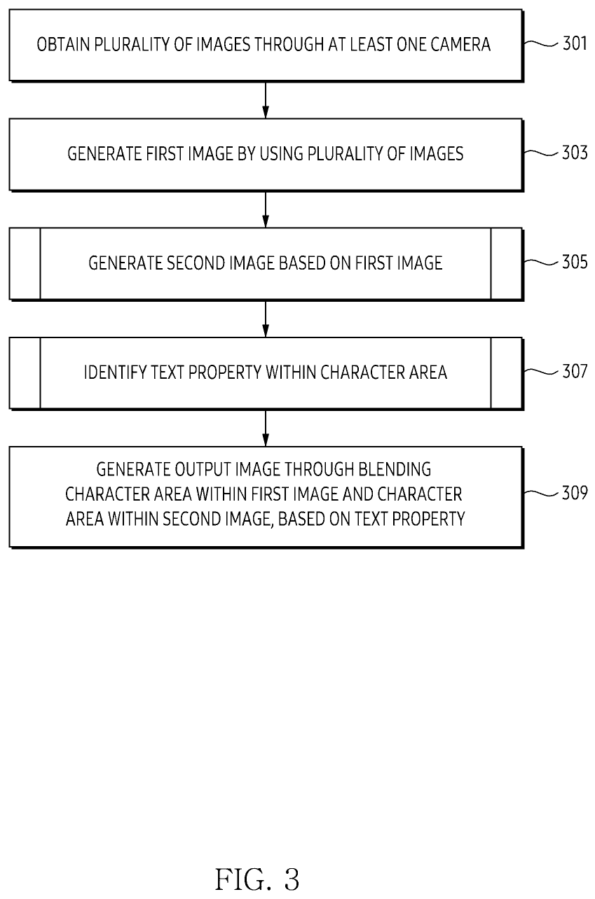

FIG. 3 is a flowchart illustrating an example output image generation operation, according to various embodiments.

Referring to FIG. 3, in operation 301, at least one processor 120 may obtain a plurality of images through at least one camera 180. According to an embodiment, the at least one processor 120 may obtain the plurality of images through the camera 180. An obtained image (e.g., the obtained image 201 of FIG. 2), which is one of the plurality of images, may include one or more texts. For example, the obtained image 201 may include text with respect to a notice written on a blackboard. For example, the obtained image 201 may include text with respect to a precaution included in a sign. For example, the obtained image 201 may include text with respect to a wireless fidelity (Wi-Fi) password attached to a wall. An intention of a user photographing an image including text may be to record the text. Text included in the obtained image 201 may lack accuracy and clarity. For example, the text may be seen blurry due to a shaky focus. For example, it may be difficult to identify a portion of the text by reflected light.

In operation 303, the at least one processor 120 may generate a first image through the plurality of images. According to an embodiment, the first image (e.g., the first image 203 of FIG. 2) may be generated by compositing portions having high clarity among the plurality of images, through a neural network for generating the first image. For example, the plurality of images may include the obtained first image, an obtained second image, and an obtained third image. The at least one processor 120 may identify a first subregion having high clarity within the obtained first image through the neural network for generating the first image. The at least one processor 120 may identify a second subregion having high clarity within the obtained second image through the neural network for generating the first image. The at least one processor 120 may identify a third subregion having high clarity within the obtained third image through the neural network for generating the first image. The at least one processor 120 may generate the first image 203 by compositing the first subregion, the second subregion, and the third subregion, through the neural network for generating the first image. The obtained first image, the obtained second image, and the obtained third image may be obtained by varying an exposure value. An exposure value of the obtained first image, an exposure value of the obtained second image, and an exposure value of the obtained third image may be different from each other. Regardless of an area including text, clarity of the first image 203 may be improved overall compared to the clarity of the obtained image 201.

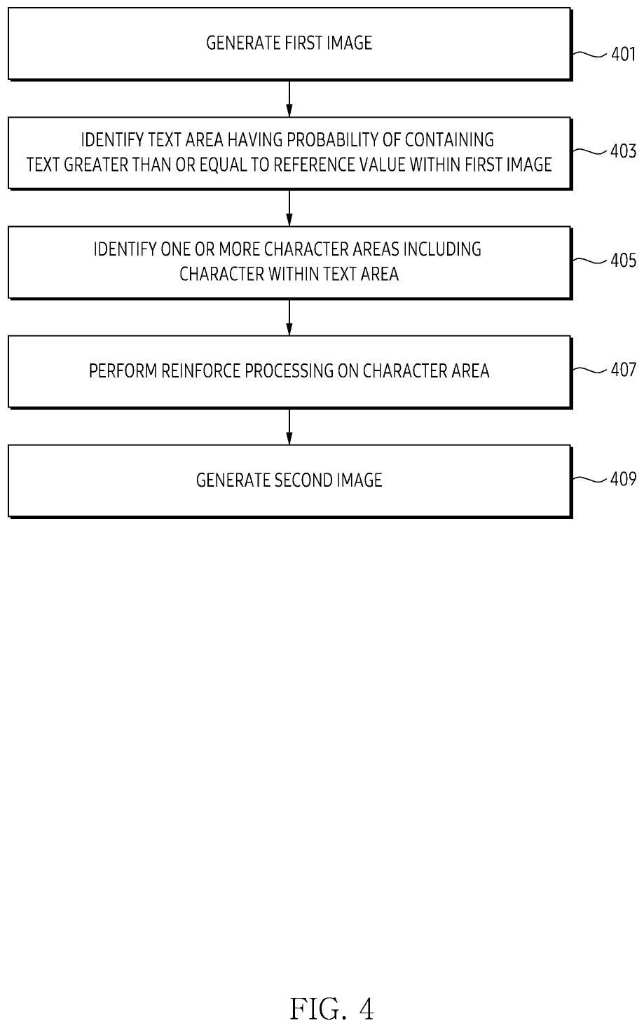

In operation 305, the at least one processor 120 may generate a second image (e.g., the second image 205 of FIG. 2) based on the first image 203. Hereinafter, a flow of the operation of generating the second image 205 is illustrated and described in greater detail below with reference to FIG. 4.

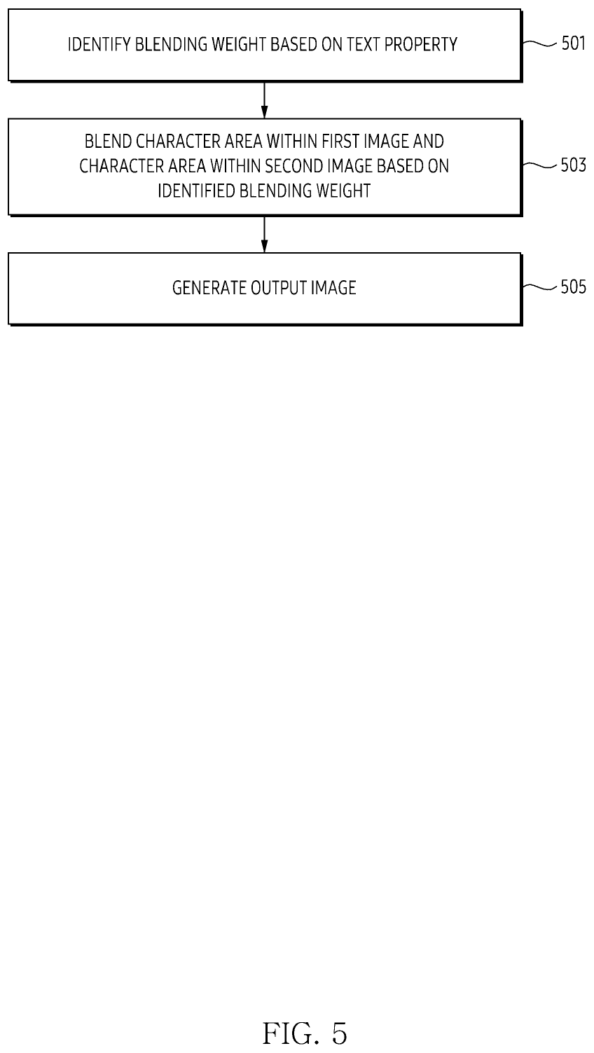

In operation 307, the at least one processor 120 may identify a text property within a character area. The text property may refer, for example, to a characteristic of a character area, such as a size and a thickness of text included in the character area and a matching probability of the character area. Hereinafter, a flow of the operation of identifying the text property within the character area is illustrated and described in greater detail below with reference to FIG. 5.

In operation 309, the at least one processor 120 may generate an output image (e.g., the output image 207 of FIG. 2) through blending a character area within the first image 203 and a character area within the second image 205, based on the text property. According to an embodiment, the output image 207 may be generated by blending the first image 203 and the second image 205. The output image 207 may be generated by blending the character area within the first image 203 and the character area within the second image 205 based on a blending weight. The blending weight may refer, for example, a ratio of the character area within the second image 205 with respect to the character area within the first image 203. Clarity with respect to a letter of the first image 203 may be lower than clarity with respect to a letter of the second image 205. The clarity may refer, for example, to a degree to which a background and a periphery of a character are contrasted. As the clarity is higher, visuality may be higher. Accuracy with respect to a character of the first image 203 may be higher than accuracy with respect to a character of the second image 205. The accuracy may refer, for example, to a degree to which a character is not recognized as another character by a user. As the accuracy is higher, typos of a character may be fewer. Therefore, the at least one processor 120 may generate an output image 207 with higher clarity than the first image 203 and higher accuracy than the second image 205, by blending the first image 203 with high accuracy and the second image 205 with high clarity. In case that the text area is not identified, the at least one processor 120 may not generate the second image 205. Accordingly, the at least one processor 120 may output the first image 203 as the output image 207. In case that the text area is identified, the at least one processor 120 may generate the output image 207, by blending the first image 203 and the second image 205 generated based on the first image 203.

FIG. 4 is a flowchart illustrating an example second image generation operation, according to various embodiments.

Referring to FIG. 4, in operation 401, at least one processor 120 may obtain a first image, e.g., a frame generated based on a plurality of obtained images obtained by a camera 180. With respect to generating the first image, the operation 301 and operation 303 of FIG. 3 may be referenced.

In operation 403, the at least one processor 120 may identify a text area having a probability of containing text greater than or equal to a reference value within the first image. The at least one processor 120 may identify the text area having the probability of containing the text greater than or equal to the reference value within the first image (e.g., the first image 203 of FIG. 2) through a neural network for generating a second image. The at least one processor 120 may identify a plurality of characters within the text area within the first image 203 through the neural network for generating the second image.

In operation 405, the at least one processor 120 may identify one or more character areas including a character within the text area. The at least one processor 120 may identify a character area included in the text area within the first image through the neural network for generating the second image. The number of characters included in the character area may be determined according to a designated standard. For example, the character area may include only an individual character in case that a size of the individual character (e.g., ‘N’, ‘O’, ‘S’, ‘M’, ‘O’, ‘K’, ‘I’, ‘N’, ‘G’, ‘A’, ‘R’, ‘E’, and ‘A’) included in the text area (e.g., ‘NO SMOKING AREA’) is greater than or equal to a designated threshold value. The character area may include a plurality of characters in case that the size of the character included in the text area is less than the designated threshold value. For example, the character area may include only the individual character in case that a space between the characters included in the text area (e.g., ‘NO SMOKING AREA’) is greater than or equal to the designated threshold value. The character area may include a plurality of characters in case that the space between the characters included in the text area is less than the designated threshold value.

In operation 407, the at least one processor may perform reinforce processing on the character area. The at least one processor 120 may perform reinforce processing on the character area through the neural network for generating the second image. The at least one processor 120 may generate a second image 205 on which reinforce processing is performed on the character area through the neural network for generating the second image. The neural network for generating the second image may be a natural processing unit (NPU). The NPU may be in a state in which learning is completed.

In operation 409, the at least one processor 120 may generate the second image 205. The at least one processor 120 may generate the second image 205 on which reinforce processing is performed on the character area within the first image 203.

FIG. 5 is a flowchart illustrating an example output image generation operation performed based on a blending weight, according to various embodiments.

Referring to FIG. 5, in operation 501, at least one processor 120 may identify a blending weight based on a text property. The text property may refer, for example, to a characteristic of a character area, such as a size and a thickness of text included in the character area, and a matching probability of the character area. The blending weight may refer, for example, to a ratio of a character area within a second image (e.g., the second image 205 of FIG. 2) with respect to a character area within a first image (e.g., the first image 203 of FIG. 2). In case that a text area is identified, the at least one processor 120 may generate an output image (e.g., the output image 207 of FIG. 2) by blending the first image 203 and the second image 205 generated based on the first image 203. The blending weight may be obtained by a blending weight identification module. The blending weight identification module may identify the blending weight based on a text property. The text property may include a size of a character included in a character area, a matching probability identified by an optical character recognition (OCR) module, a distance from a center of the first image 203 to a center of a character area, an ISO value, a sensor gain, a degree of blur, a color of the character, and/or a thickness of the character. According to an embodiment, as a size of an individual character within the character area is larger, a blending ratio of the character area within the second image 205 may be set to be higher. This is because a probability of an artifact occurring may be lower as the size of the character area is larger. The artifact may be a defect with respect to a character caused by noise within the first image 203. As a size of a letter is larger, the probability of the artifact occurring may be lower. Therefore, as the size of the letter is larger, the at least one processor 120 may set the ratio of the character area within the second image 205 to be higher than a ratio of the character area within the first image 203. According to an embodiment, as the matching probability obtained through the optical character recognition (OCR) module is larger, the blending ratio of the character area within the second image 205 may be set to be higher. The matching probability may be a probability that the character in the character area is a character identified through the optical character recognition (OCR) module. For example, the last word among English letters within the first image 203 may include one character area. The optical character recognition (OCR) module may identify a character of the character area as ‘entrances’. The optical character recognition (OCR) module may identify a matching probability that is a probability in which the character within the character area is ‘entrances’. This is because the probability of the artifact occurring may be lower as the matching probability is higher. Therefore, as the matching probability is higher, the at least one processor 120 may set the ratio of the character area within the second image 205 to be higher than the ratio of the character area within the first image 203. According to an embodiment, as a distance from the center of the first image 203 to the center of the character area is closer, the blending ratio of the character area within the second image 205 may be set to be higher. This is because the probability of the artifact occurring may be lower as the distance from the center of the first image 203 to the center of the character area is closer. This is because an image is less blurry as the distance from the center of the first image 203 to the center of the character area is closer. In the at least one processor 120, there are many cases in which a portion closer to the outside of an image is blurrier than a center of the image. Therefore, as the character area is closer to the center of the image, accuracy of the character may increase. Therefore, as the distance from the center of the first image 203 to the center of the character area is closer, the at least one processor 120 may set the ratio of the character area within the second image 205 to be higher than the ratio of the character area within the first image 203. According to an embodiment, as an international standards organization (ISO) value of the character area is lower, the blending ratio of the character area within the second image 205 may be set to be higher. This is because a probability of noise occurring within the character area may be lower as the international standards organization (ISO) value of the character area is lower. This is because the probability of the artifact occurring may be lower as the probability of noise occurring within the character area is lower. Therefore, the accuracy of the character may increase, since the probability of the artifact occurring is lower as the international standards organization (ISO) value of the character area is lower. Accordingly, as the international standards organization (ISO) value of the character area is lower, the least one processor 120 may set the ratio of the character area within the second image 205 to be higher than the ratio of the character area within the first image 203. According to an embodiment, as a thickness of the character included in the character area is thicker, the blending ratio of the character area within the second image 205 may be set to be higher. This is because the probability of the noise occurring within the character area may be lower as the thickness of the character included in the character area is thicker. This is because the probability of the artifact occurring may be lower as the probability of the noise occurring within the character area is lower. Therefore, the accuracy of the character may increase, since the probability of the artifact occurring is lower as the thickness of the character included in the character area is thicker. Therefore, as the thickness of the character included in the character area is thicker, the at least one processor 120 may set the ratio of the character area within the second image 205 to be higher than the ratio of the character area within the first image 203. According to an embodiment, as a degree of blur of the character included in the character area is lower, the blending ratio of the character area within the second image 205 may be set to be higher. The degree of blur may be identified by a blur estimation module. This is because the probability of the noise occurring within the character area may be lower as the degree of blur of the character included in the character area is lower. This is because the probability of the artifact occurring may be lower as the probability of the noise occurring within the character area is lower. Therefore, as the degree of blur of the character included in the character area is lower, the probability of the artifact occurrence is lower. If the probability of the artifact occurrence is lower, the accuracy of the character may increase. Therefore, as the degree of blur of the character is lower, the at least one processor 120 may set the ratio of the character area within the second image 205 to be higher than the ratio of the character area within the first image 203.

In operation 503, the at least one processor 120 may blend the character area within the first image 203 and the character area within the second image 205 based on the identified blending weight. The text property may refer, for example, to a characteristic of a character area, such as a size and a thickness of text included in the character area, and the matching probability of the character area. The blending weight may refer, for example, to the ratio of the character area within the second image with respect to the character area within the first image.

In operation 505, the at least one processor 120 may generate an output image 207. According to an embodiment, the output image 207 may be generated by blending the first image 203 and the second image 205. The output image 207 may be generated by blending the character area within the first image 203 and the character area within the second image 205 based on the blending weight. The blending weight may refer, for example, to the ratio of the character area within the second image 205 with respect to the character area within the first image 203. Clarity with respect to a letter of the first image 203 may be lower than clarity with respect to a letter of the second image 205. The clarity may refer, for example, to a degree to which a background and a periphery of a character are contrasted. As the clarity is higher, visuality may be higher. Accuracy with respect to a character of the first image 203 may be higher than accuracy with respect to a character of the second image 205. The accuracy may refer, for example, to a degree to which a character is not recognized as another character by the user. As the accuracy is higher, typos of a character may be fewer. Therefore, the at least one processor 120 may generate the output image 207 with higher clarity than the first image 203 and higher accuracy than the second image 205, by blending the first image 203 and the second image 205. In case that the text area is not identified, the at least one processor 120 may not generate the second image 205. Accordingly, the at least one processor 120 may output the first image 203 as the output image 207. In case that the text area is identified, the at least one processor 120 may generate the output image 207, by blending the first image 203 and the second image 205 generated based on the first image 203.

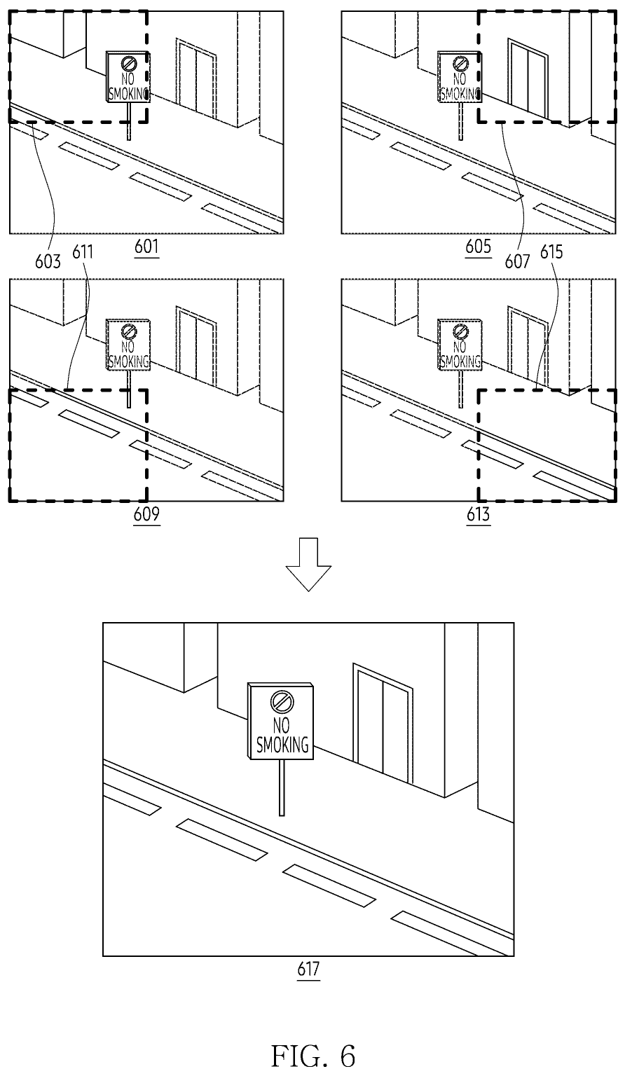

FIG. 6 is a diagram illustrating an example of first image generation, according to various embodiments.

Referring to FIG. 6, an obtained first image 601, an obtained second image 605, an obtained third image 609, and an obtained fourth image 613 may be an image obtained by a camera 180. A subregion 603 within the obtained first image may be a portion with higher clarity than other obtained images (e.g., the obtained second image 605, the obtained third image 609, and the obtained fourth image 613), within the obtained first image 601. A subregion 607 within the obtained second image may be a portion with higher clarity than other obtained images (e.g., the obtained first image 601, the obtained third image 609, and the obtained fourth image 613), within the obtained second image 605. A subregion 611 within the obtained third image may be a portion with higher clarity than other obtained images (e.g., the obtained first image 601, the obtained second image 605, and the obtained fourth image 613), within the obtained third image 609. A subregion 615 within the obtained fourth image may be a portion with higher clarity than other obtained images (e.g., the obtained first image 601, the obtained second image 605, and the obtained third image 609), within the obtained fourth image 613. A first image 617 may be generated based on the obtained images (e.g., the obtained first image 601, the obtained second image 605, the obtained third image 609, and the obtained fourth image 613) obtained through the camera 180. For example, at least one processor 120 may generate the first image 617 by compositing the subregion 603 within the obtained first image 601, the subregion 607 within the obtained second image, the subregion 611 within the obtained third image, and the subregion 615 within the obtained fourth image through a neural network for generating the first image. The first image 617 may have higher clarity overall than the obtained images. However, clarity of a character included in the first image may not be higher than clarity of a background portion. In case of photographing an image including text, an intention of a user may be to record information contained in the character. Therefore, the at least one processor 120 may perform reinforce processing on the character so that the characters may be easily identified by the user. The reinforce processing may be a process of increasing clarity of the character and lowering accuracy of the character. Hereinafter, second image generation performed based on the first image will be described.

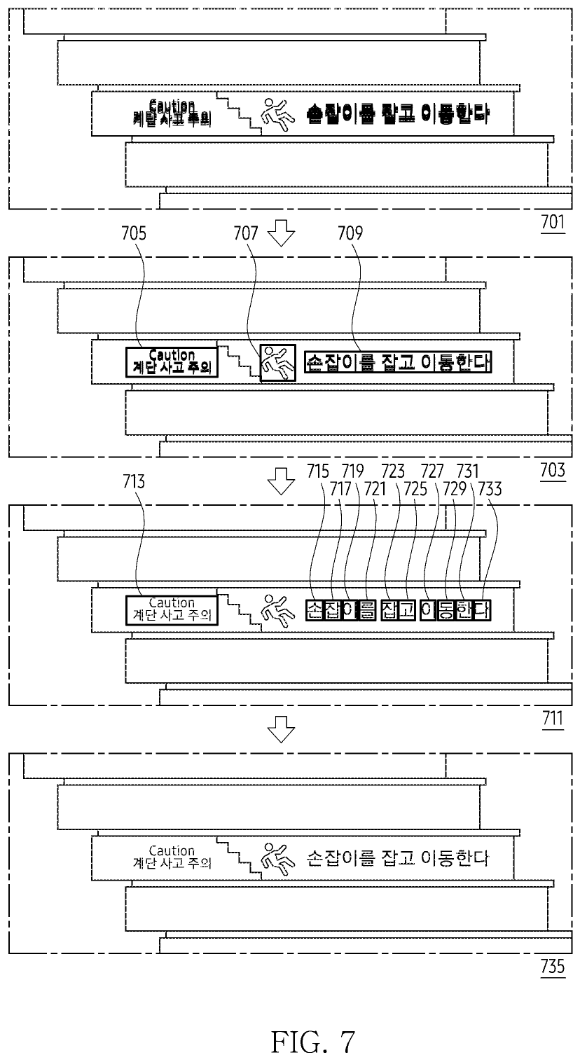

FIG. 7 is a diagram illustrating an example of second image generation, according to various embodiments.

Referring to FIG. 7, in a first process 701, at least one processor 120 may generate a first image (e.g., the first image 203 of FIG. 2) based on a plurality of images obtained from a camera 180.

According to an embodiment, the at least one processor 120 may obtain a plurality of images through the camera 180. An obtained image (e.g., the obtained image 201 of FIG. 2), which is one of the plurality of images, may include one or more texts. For example, the obtained image 201 may include text with respect to a notice written on a blackboard. For example, the obtained image 201 may include text with respect to a precaution included in a sign. For example, the obtained image 201 may include text with respect to a wireless fidelity (Wi-Fi) password attached to a wall. An intention of a user photographing an image including text may be to record the text. Text included in the obtained image 201 may lack accuracy and clarity. For example, the text may be seen blurry due to a shaky focus. For example, it may be difficult to identify a portion of the text by reflected light.

According to an embodiment, the first image 203 may be generated by compositing portions having high clarity among the plurality of images through a neural network for generating the first image 203. For example, the plurality of images may include an obtained first image, an obtained second image, and an obtained third image. The at least one processor 120 may identify a first subregion with high clarity within the obtained first image through the neural network for generating the first image 203. The at least one processor 120 may identify a second subregion with high clarity within the obtained second image through the neural network for generating the first image 203. The at least one processor 120 may identify a third subregion with high clarity within the obtained third image through the neural network for generating the first image 203. The at least one processor 120 may generate the first image 203 by compositing the first subregion, the second subregion, and the third subregion through the neural network for generating the first image 203. The obtained first image, the obtained second image, and the obtained third image may be obtained by varying an exposure value. An exposure value of the obtained first image, an exposure value of the obtained second image, and an exposure value of the obtained third image may be different from each other. Regardless of an area including the text, clarity of the first image 203 may be improved overall compared to the clarity of the obtained image 201.

In a second process 703, the at least one processor 120 may identify whether one or more subregions (e.g., a first area 705, a second area 707, and a third area 709) included in the first image 203 are a text area. The first area 705 may be a review area that has a probability of containing text, within the first image 203. The first area 705 may be a text area that has a high probability of containing text. The second area 707 may be a review area within a second image (e.g., the second image 205 of FIG. 2) that has a probability of containing text. Since the probability of containing text is low, the second area 707 may not be a text area. The third area 709 may be a review area within the third image that has a probability of containing text. The third area 709 may be a text area that has a high probability of containing text. The at least one processor 120 may identify a text area that has a probability of containing text greater than or equal to a reference value within the first image 203 through a neural network for generating the second image. For example, the at least one processor 120 may identify the first area 705 as a text area through the neural network for generating the second image. For example, the at least one processor 120 may identify the third area 709 as a text area through the neural network for generating the second image.

In the third process 711, the at least one processor 120 may identify a character area included in the text area within the first image 203 through the neural network for generating the second image. The number of characters to be included in a first character area 713 (in Korean language, ‘Caution, [symbol] ), a second character area 715 (in Korean language, ‘ [symbol] ’), a third character area 717 (in Korean language, ‘ [symbol] ’), a fourth character area 719 (in Korean language, ‘ [symbol] ’), a fifth character area 721 (in Korean language, ‘ [symbol] ’), a sixth character area 723 (in Korean language, ‘ [symbol] ’), a seventh character area 725 (in Korean language, ‘ [symbol] ’), an eighth character area 727 (in Korean language, ‘ [symbol] ’), a ninth character area 729 (in Korean language, ‘ [symbol] ’), a tenth character area 731 (in Korean language, ‘ [symbol] ’), and an eleventh character area 733 (in Korean language, ‘ [symbol] ’) may be determined according to a designated standard such as a size of an individual character and a space between the characters. The at least one processor 120 may identify the character area included in the text area within the first image 203 through the neural network for generating the second image. The number of characters included in the character area may be determined according to the designated standard. For example, in case that a size of an individual character (e.g., in Korean language ‘ [symbol] ’, ‘ [symbol] ’, ‘ [symbol] ’, and ‘ [symbol] ’ included in a text area (e.g., in Korean language ‘ [symbol] ’) is greater than or equal to a designated threshold value, the character area may include only the individual character. For example, since the size of the individual character included in the text area (e.g., the third area 709) is greater than or equal to the designated threshold value, the second character area 715, the third character area 717, the fourth character area 719, the fifth character area 721, the sixth character area 723, the seventh character area 725, the eighth character area 727, the ninth character area 729, the tenth character area 731, and the eleventh character area 733 may include only the individual character. The character area may include a plurality of characters when the size of the character included in the text area is less than the designated threshold value. For example, since the size of the individual character included in the text area (e.g., the first area 705) is less than the designated threshold value, the first character area 713 may include a plurality of characters (e.g., in Korean language, CAUTION, [symbol] ). For example, in case that the space between the characters included in the text area (e.g., in Korean language, ‘ [symbol] ’) is greater than or equal to the designated threshold value. the character area may include only the individual character (e.g., in Korean language, ‘ [symbol] ’, ‘ [symbol] ’, ‘ [symbol] ’, and ‘ [symbol] ’). For example, since the space between characters included in the text area (e.g., the third area 709) is greater than or equal to the designated threshold value, the second character area 715, the third character area 717, the fourth character area 719, the fifth character area 721, the sixth character area 723, the seventh character area 725, the eighth character area 727, the ninth character area 729, the tenth character area 731, and the eleventh character area 733 may include only the individual character. In case that the space between characters included in the text area is less than the designated threshold value, the character area may include a plurality of characters. For example, since the space between characters included in the text area (e.g., the first area 705) is less than the designated threshold value, the first character area 713 may include the plurality of characters (e.g., in Korean language, Cation, [symbol] ). The at least one processor 120 may perform reinforce processing on the character areas (e.g., the first character area 713, the second character area 715, the third character area 717, the fourth character area 719, the fifth character area 721, the sixth character area 723, the seventh character area 725, the eighth character area 727, the ninth character area 729, the tenth character area 731, and the eleventh character area 733), through the neural network for generating the second image. The at least one processor 120 may generate the second image 205 on which reinforce processing is performed on the character areas through the neural network for generating the second image. The neural network for generating may be a natural processing unit (NPU). The NPU may be in a state in which learning is completed.

In a fourth process 735, the at least one processor 120 may generate the second image 205 based on the first image 203. In characters included in the second image 205, clarity may be improved compared to the first image 203. The clarity may refer, for example, to a degree to which a background and a periphery of a character are contrasted. As the clarity is higher, visuality may be higher. Accuracy with respect to a character of the first image 203 may be higher than accuracy with respect to a character of the second image 205. The accuracy may refer, for example, to a degree to which the character is not recognized as another character by a user. As the accuracy is higher, typos of the character may be fewer. Therefore, the at least one processor 120 may generate an output image with higher clarity than the first image 203 and higher accuracy than the second image 205, by blending the first image 203 with high accuracy and the second image 205 with high clarity. Hereinafter, an example of blending weight identification for generating the output image will be described.

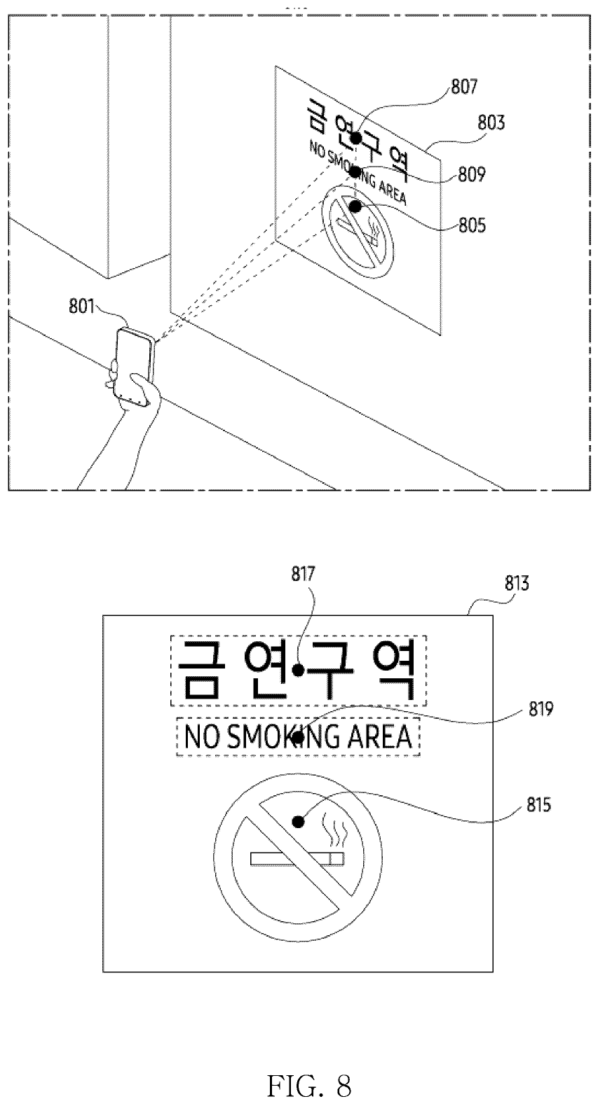

FIG. 8 is a diagram illustrating an example of blending weight identification, according to various embodiments.

Referring to FIG. 8, an electronic device 801 including a camera 180 may obtain an image including text. An object 803 including text may be photographed by the electronic device 801. A center 805 of an object may be a center of the object 803 including the text. A first point 807 of the object may be a point corresponding to a center of a character area including a character (e.g., in Korean language, [symbol] ). A second point 809 of the object may be a point corresponding to a center of a character area including a character (e.g., NO SMOKING AREA). According to embodiments, in case that a text area (e.g., the first area 705 of FIG. 7) is identified, the at least one processor 120 may generate an output image by blending a first image (e.g., the first image 203 of FIG. 2) and a second image (e.g., the second image 205 of FIG. 2) generated based on the first image 203. The blending weight may be obtained by a blending weight identification module. The blending weight identification module may identify the blending weight based on a text property. The blending weight may refer, for example, to a ratio of a character area within the second image 205 with respect to a character area within the first image 203. The text property may include a distance from a center of the first image 203 to a center of a character area 713. According to an embodiment, as the distance from the center of the first image 203 to the center of the character area 713 is closer, a blending ratio of the character area within the second image 205 may be set to be higher. For example, the distance from the center of the first image 203 corresponding to the center 805 of the object to the center of the character area corresponding to the first point 807 of the object may be longer than the distance from the center of the first image to the center of the character area corresponding to the second point 809 of the object. As the distance from the center of the first image 203 to the center of the character area is farther, the blending ratio of the character area within the second image 205 may be set to be higher. Therefore, the blending ratio of the character area within the second image 205 of the character area corresponding to the first point 807 of the object may be higher than the blending ratio of the character area within the second image 205 of the character area corresponding to the second point 809 of the object. The blending weight may refer, for example, to a ratio of the character area within the second image 205 with respect to the character area within the first image 203. Therefore, the character area corresponding to the first point 807 of the object may have a higher blending weight than the character area corresponding to the second point 809 of the object. This is because a probability of an artifact occurring may be lower as the distance from the center of the first image 203 to the center of the character area 713 is closer. This is because the image is less blurry as the distance from the center of the first image 203 to the center of the character area 713 is closer. In the at least one processor 120, there are many cases in which a portion closer to the outside of the image is blurrier than the center of the image. Therefore, as the character area is closer to the center of the image, accuracy of the character may increase. Therefore, as the distance from the center of the first image 203 to the center of the character area 713 is closer, the at least one processor 120 may set the ratio of the character area within the second image 205 to be higher than a ratio of the character area 713 within the first image 203. In other words, the character area corresponding to the first point 807 of the object may be set to have a higher blending weight than the character area corresponding to the second point 809 of the object.

A first image 813 may be generated based on a plurality of images obtained from the camera 180 of the electronic device 801. The first image may include a portion corresponding to the object 803 including the text. A center 815 of the first image may correspond to the center 805 of the object. A center 817 of a first character area may correspond to the first point 807 of the object. A center 819 of a second character area may correspond to the second point 809 of the object. According to embodiments, in case that the text area (e.g., the first area 705 of FIG. 7) is identified, the at least one processor 120 may generate the output image by blending the first image 813 and the second image (e.g., the second image 205 of FIG. 2) generated based on the first image 813. The blending weight may be obtained by the blending weight identification module. The blending weight identification module may identify the blending weight based on the text property. The blending weight may refer, for example, to the ratio of the character area within the second image with respect to the character area within the first image. The text property may include a distance from a center of the first image 813 to a center (e.g., the center 817 of the first character area and the center 819 of the second character area) of a character area. According to an embodiment, as the distance from the center of the first image 813 to a center 817 or 819 of the character area is closer, the blending ratio of the character area within the second image 205 may be set to be higher. For example, a distance from the center 815 of the first image corresponding to the center 805 of the object to the center 817 of the first character area may be longer than a distance from the center of the first image to the center 819 of the second character area. As a distance from the center 815 of the first image to the center 817 or 819 of the character area is farther, the blending ratio of the character area within the second image 205 may be set to be higher. Therefore, the blending ratio of the character area within the second image 205 of the first character area may be higher than the blending ratio of the character area within the second image 205 of the second character area. The blending weight may refer, for example, to the ratio of the character area within the second image with respect to the character area within the first image. Therefore, a blending weight of the first character area may be higher than a blending weight of the second character area. This is because the probability of the artifact occurring may be lower as the distance from the center 815 of the first image to the center 817 or 819 of the character area is closer. This is because the image may be less blurry as the distance from the center 815 of the first image to the center 817 or 819 of the character area is closer. In the at least one processor 120, there are many cases in which a portion closer to the outside of the image is blurrier than the center of the image. Therefore, as the character area is closer to the center of the image, the accuracy of the character may increase. Therefore, as the distance from the center 815 of the first image to the center 817 or 819 of the character area is closer, the at least one processor 120 may set the ratio of the character area within the second image 205 to be higher than the ratio of the character area within the first image. In other words, the first character area may be set to have a higher blending weight than the second character area.

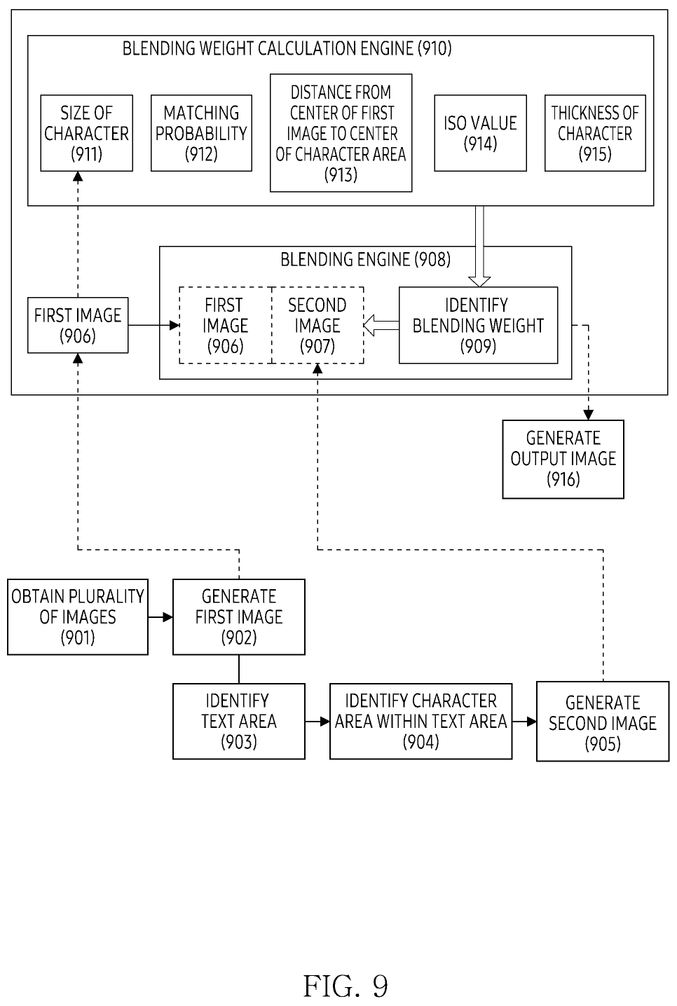

FIG. 9 is a diagram illustrating example operations of generating an output image, according to various embodiments.

Referring to FIG. 9, in operation 901, at least one processor 120 may obtain a plurality of images through a camera 180. In operation 902, the at least one processor 120 may generate a first image. In operation 903, the at least one processor 120 may identify a text area within the first image. In operation 904, the at least one processor 120 may identify a character area within the text area. In operation 905, the at least one processor 120 may generate a second image based on the first image. A first image 906 may be generated based on the plurality of images. The first image 906 may be input to a blending weight calculation engine 910 and a blending engine 908. A second image 907 may be generated based on the first image. In the blending engine 908, the at least one processor 120 may obtain a blending weight 909 from the blending weight calculation engine 910. In the blending engine 908, the at least one processor 120 may blend the first image 906 and the second image 907 based on the identified blending weight. In the blending engine 908, the at least one processor 120 may generate an output image 916 by blending the first image 906 and the second image 907. In the blending weight calculation engine 910, the at least one processor 120 may calculate the blending weight based on a first reference 911. The first reference 911 may be a size of a letter. In the blending weight calculation engine 910, the at least one processor 120 may identify the blending weight based on a second reference 912. The second reference 912 may be a matching probability. The matching probability may be a probability that a character within a character area is a character identified through an optical character recognition (OCR) module. In the blending weight calculation engine 910, the at least one processor 120 may identify the blending weight based on a third reference 913. The third reference 913 may be a distance from a center of the first image to a center of the character area. In the blending weight calculation engine 910, the at least one processor 120 may identify the blending weight based on a fourth reference 914. The fourth reference 914 may be an international standards organization (ISO) value. In the blending weight calculation engine 910, the at least one processor 120 may identify the blending weight based on a fifth reference 915. The fifth reference 915 may be a thickness of a character.

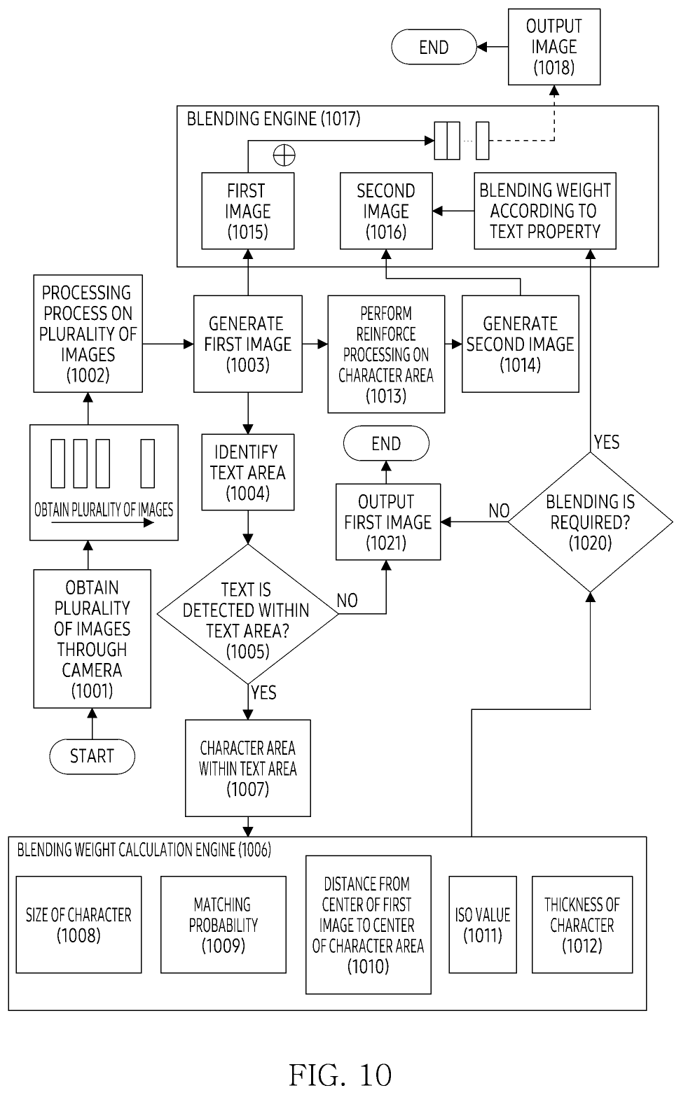

FIG. 10 is a diagram illustrating example operations of generating an output image based on text area identification, according to various embodiments.

Referring to FIG. 10, in operation 1001, at least one processor 120 may obtain a plurality of images through a camera 180. In operation 1002, the at least one processor 120 may perform a processing process on the plurality of images. In operation 1003, the at least one processor 120 may generate a first image. The first image generated in operation 1003 may be input to a blending engine 1017 and a blending weight calculation engine 1006. In operation 1004, the at least one processor 120 may identify a text area within the first image. In operation 1005, the at least one processor 120 may identify whether text is detected within the text area. In case that the text is detected within the text area, the at least one processor 120 may perform operation 1007. In case that the text is not detected within the text area, the at least one processor 120 may perform operation 1021. In the operation 1007, the at least one processor 120 may identify a character area within the text area. In the blending weight calculation engine 1006, the at least one processor 120 may calculate a blending weight based on a first reference 1008. The first reference 1008 may be a size of a character. In the blending weight calculation engine 1006, the at least one processor 120 may identify the blending weight based on a second reference 1009. The second reference 1009 may be a matching probability. The matching probability may be a probability that a character in a character area is a character identified through an optical character recognition (OCR) module. In the blending weight calculation engine 1006, the at least one processor 120 may identify the blending weight based on a third reference 1010. The third reference 1010 may be a distance from a center of the first image to a center of the character area. In the blending weight calculation engine 1006, the at least one processor 120 may identify the blending weight based on a fourth reference 1011. The fourth reference 1011 may be an international standards organization (ISO) value. In the blending weight calculation engine 1006, the at least one processor 120 may identify the blending weight based on a fifth reference 1012. The fifth reference 1012 may be a thickness of a character. After the blending weight is identified by the blending weight calculation engine 1006, the at least one processor 120 may perform operation 1020. In the operation 1020, the at least one processor 120 may identify whether blending is required based on the blending weight. In the operation 1020, the at least one processor 120 may identify a need for the blending based on the blending weight greater than or equal to a threshold value. In case that the at least one processor 120 identifies the need for blending, the at least one processor 120 may generate an output image 1018 through the blending engine 1017. In operation 1013, the at least one processor 120 may perform reinforce processing on the character area of the first image. In operation 1014, the at least one processor 120 may generate a second image. In the blending engine 1017, the at least one processor 120 may blend a first image 1015 and a second image 1016 based on the blending weight according to a text property. In the blending engine 1017, the at least one processor 120 may generate the output image 1018 by blending the first image 1015 and the second image 1016.

As described above, an electronic device according to an example embodiment may comprise: at least one processor, comprising processing circuitry, and at least one camera, wherein at least one processor, individually and/or collectively, may be configured to: obtain a plurality of images through the at least one camera; generate a first image using the plurality of images; based on identifying that the plurality of images are related to text, identify a character area within the first image; generate a second image on which reinforce processing is performed on the character area within the first image; and generate an output image by blending the character area within the first image and a character area within the second image, based on a text property of the character area within the first image.

According to an example embodiment, in order to blend the character area within the first image and the character area within the second image, as a position of the character area is closer from a position of a center of the obtained first image, a ratio of the character area within the second image may be set to be higher.

According to an example embodiment, the electronic device may further comprise: an optical character recognition (OCR) module including circuitry, and at least one processor, individually and/or collectively, may be configured to: identify a character within the character area through the OCR module; and identify a matching probability being a probability that the character is a character identified through the OCR module. In order to blend the character area within the first image and the character area within the second image, as the matching probability is higher, a ratio of the character area within the second image may be set to be higher.

According to an example embodiment, in order to blend the character area within the first image and the character area within the second image, as a size of an individual character within the character area is larger, a ratio of the character area within the second image may be set to be higher.

According to an example embodiment, in order to blend the character area within the first image and the character area within the second image, as an international standards organization (ISO) value within the character area is lower, a ratio of the character area within the second image may be set to be higher.

According to an example embodiment, in order to blend the character area within the first image and the character area within the second image, as a thickness of a character within the character area is thicker, a ratio of the character area within the second image may be set to be higher.

According to an example embodiment, at least one processor, individually and/or collectively, may be configured to, in order to blend the character area within the first image and the character area within the second image, as a character within the character area is less blurry, set a ratio of the character area within the second image to be higher.

According to an example embodiment, at least one processor, individually and/or collectively, may be configured to, in order to obtain the first image, merge a first subregion within the obtained first image and a second subregion within the obtained second image through a neural network to increase resolution of the image.

According to an example embodiment, at least one processor, individually and/or collectively, may be configured to, in order to identify the character area, identify a text area that has a probability of containing text greater than or equal to a reference value within the first image. According to an example embodiment, at least one processor, individually and/or collectively, may be configured to identify the character area within the text area.

According to an example embodiment, the electronic device may further comprise a neural processing unit (NPU) comprising circuitry configured to generate the second image; and generate the second image on which reinforce processing is performed on the character area using a learned neural network.

According to an example embodiment, at least one processor, individually and/or collectively, may be configured to identify a plurality of characters within the text area within the first image. The character area within the first image may include individual characters among the plurality of characters.

As described above, a method performed by an electronic device according to an example embodiment may comprise: obtaining a plurality of images through at least one camera; generating a first image using the plurality of images; based on identifying that the plurality of images are related to text, identifying a character area within the first image; generating a second image on which reinforce processing is performed on the character area; and generating an output image by blending the character area within the first image and a character area within the second image based on a text property of the character area within the first image.

According to an example embodiment, the method may comprise, in the blending the character area within the first image and the character area within the second image, as a position of the character area is closer from a position of a center of the obtained first image, setting a ratio of the character area within the second image to be higher.

According to an example embodiment, the method may further comprise identifying a character within the character area through an optical character recognition (OCR) module. The method may further comprise identifying a matching probability being a probability that the character is a character identified through the OCR module. In the blending the character area within the first image and the character area within the second image, as the matching probability is higher, a ratio of the character area within the second image may be set to be higher.

According to an example embodiment, in the blending the character area within the first image and the character area within the second image, as a size of an individual character within the character area is larger, a ratio of the character area within the second image may be set to be higher.

According to an example embodiment, in the blending the character area within the first image and the character area within the second image, as an international standards organization (ISO) value within the character area is lower, a ratio of the character area within the second image may be set to be higher.

According to an example embodiment, the blending the character area within the first image and the character area within the second image may comprise, as a thickness of a character within the character area is thicker, setting a ratio of the character area within the second image to be higher.

According to an example embodiment, the obtaining the first image may comprise merging a first subregion within a first frame and a second subregion within a second frame, using a neural network to increase resolution of the image.

According to an example embodiment, the identifying the character area may comprise identifying a text area that has a probability of containing text greater than or equal to a reference value within the first image. The identifying the character area may comprise identifying the character area within the text area.

According to an example embodiment, the generating the second image may comprise generating the second image on which reinforce processing is performed on the character area using a learned neural network.

According to an example embodiment, the method may comprise identifying a plurality of characters within the text area within the first image. In the method, the character area within the first image may include individual characters among the plurality of characters.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), the element may be coupled with the other element directly (e.g., wiredly), wirelessly, or via a third element.

As used in connection with various embodiments of the disclosure, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

No claim element is to be construed under the provisions of 35 U.S.C. § 112, sixth paragraph, unless the element is expressly recited using the phrase “means for” or “means”.

What is claimed is:

1. An electronic device comprising:
at least one processor, comprising processing circuitry; and
at least one camera; and
memory storing instructions that, when executed by the at least one processor individually and/or collectively, cause the electronic device to:
obtain a plurality of images through the at least one camera;
generate a first image using the plurality of images;
based on identifying that the plurality of images are related to a text, identify a character area within the first image;
generate a second image on which reinforce processing is performed on the character area within the first image; and
generate an output image by blending the character area within the first image and a character area within the second image based on a text property of the character area within the first image.

2. The electronic device of claim 1,
wherein, to blend the character area within the first image and the character area within the second image, as a position of the character area is closer to a position of a center of the obtained first image, a ratio of the character area within the second image is set to be higher.

3. The electronic device of claim 1, further comprising:
an optical character recognition (OCR) module comprising circuitry, and
wherein the instructions, when executed by the at least one processor individually and/or collectively, cause the electronic device to:
identify a character within the character area through the OCR module; and
identify a matching probability being a probability that the character is a character identified through the OCR module,
wherein, to blend the character area within the first image and the character area within the second image, as the matching probability is higher, a ratio of the character area within the second image is set to be higher.

4. The electronic device of claim 1,
wherein, to blend the character area within the first image and the character area within the second image, as a size of an individual character within the character area is larger, a ratio of the character area within the second image is set to be higher.

5. The electronic device of claim 1,
wherein, to blend the character area within the first image and the character area within the second image, as an international standards organization (ISO) value within the character area is lower, the ratio of the character area within the second image is set to be higher.

6. The electronic device of claim 1,
wherein the instructions, when executed by the at least one processor individually and/or collectively, cause the electronic device to:
as a thickness of a character within the character area is thicker, set a ratio of the character area within the second image to be higher.

7. The electronic device of claim 1,
wherein the instructions, when executed by the at least one processor individually and/or collectively, cause the electronic device to:
as a character within the character area is less blurry, set a ratio of the character area within the second image to be higher.

8. The electronic device of claim 1,
wherein the instructions, when executed by the at least one processor individually and/or collectively, cause the electronic device to:
merge a first subregion within the obtained first image and a second subregion within the obtained second image through a neural network to increase resolution of the image.

9. The electronic device of claim 1,
wherein the instructions, when executed by the at least one processor individually and/or collectively, cause the electronic device to:
identify a text area that has a probability of containing text greater than or equal to a reference value within the first image; and
identify the character area within the identified text area.

10. The electronic device of claim 1, further comprising:
a neural processing unit (NPU) comprising circuitry configured to generate the second image,
wherein the NPU is configured to generate the second image on which reinforce processing is performed on the character area using a learned neural network.

11. The electronic device of claim 1,
wherein the instructions, when executed by the at least one processor individually and/or collectively, cause the electronic device to:
identify a plurality of characters within the text area within the first image, and
wherein the character area within the first image includes individual characters among the plurality of characters.

12. A method performed by an electronic device, the method comprising:
obtaining a plurality of images through at least one camera;
generating a first image using the plurality of images;
based on identifying that the plurality of images are related to a text, identifying a character area within the first image;
generating a second image on which reinforce processing is performed on the character area; and
generating an output image by blending the character area within the first image and a character area within the second image based on a text property of the character area within the first image.

13. The method of claim 12,
wherein, in the blending the character area within the first image and the character area within the second image, as a position of the character area is closer to a position of a center of the obtained first image, a ratio of the character area within the second image is set to be higher.

14. The method of claim 12, further comprising:
identifying a character within the character area through an optical character recognition (OCR) module; and
identifying a matching probability being a probability that the character is a character identified through the OCR module,
wherein, in the blending the character area within the first image and the character area within the second image, as the matching probability is higher, a ratio of the character area within the second image is set to be higher.

15. The method of claim 12,
wherein, in the blending the character area within the first image and the character area within the second image, as a size of an individual character within the character area is larger, a ratio of the character area within the second image is set to be higher.

16. The method of claim 12,
wherein, to blend the character area within the first image and the character area within the second image, as an international standards organization (ISO) value within the character area is lower, the ratio of the character area within the second image is set to be higher.

17. The method of claim 12, wherein, as a thickness of a character within the character area is thicker, a ratio of the character area within the second image is set to be higher.

18. The method of claim 12,,
wherein, as a character within the character area is less blurry, a ratio of the character area within the second image is set to be higher.

19. The method of claim 11, wherein the generating the first image comprises:
merging a first subregion within the obtained first image and a second subregion within the obtained second image through a neural network to increase resolution of the image.

20. A non-transitory computer-readable storage medium configured to store instructions that, when executed by at least one processor individually or collectively, cause an electronic device to perform operations including:
obtaining a plurality of images through at least one camera;
generating a first image using the plurality of images;
based on identifying that the plurality of images are related to a text, identifying a character area within the first image;
generating a second image on which reinforce processing is performed on the character area; and
generating an output image by blending the character area within the first image and a character area within the second image based on a text property of the character area within the first image.
